(19) United States
(12) Patent Application Publication
(10) Pub. No.: US 2021/0118385 A1
(43) Pub. Date: Apr. 22, 2021

(54) PIXEL DRIVING CIRCUIT AND LCD PANEL

(71) Applicant: Shenzhen China Star Optoelectronics Technologies Co., Ltd., Shenzhen (CN)

(72) Inventor: Jinjie Wang, Shenzhen (CN)

(21) Appl. No.: 16/319,313

(22) PCT Filed: Sep. 26, 2018
(86) PCT No.: PCT/CN2018/107772

§ 371 Date: Jan. 18, 2019

(30) Foreign Application Priority Data
Jul. 17, 2018 (CN) 201810786716.7

(51) Int. Cl. G09G 3/36; G02F 1/1362; G02F 1/1368

(52) U.S. Cl. CPC G09G 3/3648; G02F 1/1368; G02F 1/136222; G02F 1/136213

(57) ABSTRACT

The present invention teaches a pixel driving circuit and a LCD panel. The pixel driving circuit adopts a 2T structure to achieve color shift improvement by series-connecting a divider capacitor Cs to the secondary liquid crystal capacitor Clc2, or by providing a secondary TFT T2 with a ditch aspect ratio smaller than that of the main TFT T1. As such, the secondary liquid crystal capacitor Clc2 has a voltage smaller than that of the main liquid crystal capacitor Clc1 so that color shift is improved. Compared to the existing 3T-structure pixel driving circuit, the present invention omits the third TFT for discharging the secondary region and may remove the impact of the third TFT's discharge to the common electrode Acom on the array substrate side, reduce lateral crosstalk, and further enhance pixel aperture ratio.

### FIELD OF THE INVENTION

The present invention is generally related to the field of display technology, and more particularly to a pixel driving circuit and a LCD panel.

### BACKGROUND OF THE INVENTION

Liquid crystal display (LCD) panels are widely applied to TVs, smart phones, digital cameras, tablet computers, computer screens, and notebook screens, due to their thin thickness, power saving, and low radiation.

A LCD panel includes a color filter (CF) substrate, a thin film transistor (TFT) array substrate, and a liquid crystal layer disposed between the two substrates. The LCD panel has multiple pixels arranged in an array. By applying driving voltages across the substrates, the pixels display images under the driving of pixel circuit.

Currently, there are three major types of LCD panels: Twisted Nematic (TN) or Super Twisted Nematic (STN0, In-Plane Switching (IPS), and Vertical Alignment (VA) LCD panels. Compared to other LCD panels, VA LCD panels have higher contrast, and are widely applied to large-screen LCD TVs.

Most of existing VA LCD panels adopt a pixel driving circuit of a 3T structure, i.e., having three thin film transistors (TFTs). As shown in FIG. 1, the 3T structure includes a first TFT T100 in a main region PM, and a second TFT T200 and a third TFT T300 both in a secondary region PS. The first TFT T100 has its gate electrically connected to a scan line G(n) where n is a positive integer indicating the row that the pixel is located, its source electrically connected a data line D(m) where m is a positive integer indicating the column that the pixel is located, and its drain electrically connected a first storage capacitor Cst1 and a first liquid crystal capacitor Clc1. The second TFT T200 has its gate electrically connected to the scan line G(n), its source electrically connected the data line D(m), and its drain electrically connected a second storage capacitor Cst2 and a second liquid crystal capacitor Clc2. The third TFT T300 has its gate electrically connected to the scan line G(n), its source electrically connected the drain of the second TFT T200, and its drain electrically connected a common electrode Acom on the array substrate.

When a scan signal on the scan line G(n) functions, the first TFT T100 in the main region PM is turned on. A data signal on the data line D(m) charges the first storage capacitor Cst1 and the first liquid crystal capacitor Clc1. In the meantime, the second TFT T200 and the third TFT T300 in the secondary region PS are also turned on. The data signal on the data line D(m) charges the second storage capacitor Cst2 and the second liquid crystal capacitor Clc2, while the turned-on third TFT T300 discharges towards the common electrode Acom on the array substrate side. After the scan signal on the scan line G(n) stops, the second liquid crystal capacitor Clc2 in the secondary region PS has a voltage lower than that of the liquid crystal capacitor Clc1 in the main region PM, thereby achieving the reduction of color shift.

Due to the stability of the manufacturing process, the TFTs in the above 3T structure, especially the third TFT T300, suffer greater variances in the aspect ratio of their ditches, leading to greater fluctuation in their IV characteristics. Then, the discharge from the third TFT T300 towards the common electrode Acom may lead to voltage jump of greater variances at the common electrode Acom when displaying images. Affected by the voltage jump at the common electrode Acom on the array substrate side, the displayed image may show lateral crosstalk phenomenon.

### SUMMARY OF THE INVENTION

An objective of the present invention is to teach a pixel driving circuit capable of improving color shift, removing the impact of the third TFT's discharge in the existing 3T-structure pixel driving circuit to the common electrode on the array substrate side, reducing lateral crosstalk, and further enhancing pixel aperture ratio.

Another objective of the present invention is to teach a LCD panel having smaller color shift, less crosstalk, and better pixel aperture ratio.

To achieve the objectives, the present invention teaches a pixel driving circuit involving only two TFTs. The pixel driving circuit includes a main region and a secondary region.

The main region comprises a main TFT, a main storage capacitor, and a main liquid crystal capacitor; the main TFT has its gate electrically connected to the a scan line, its source electrically connected to a data line, and its drain electrically connected to a terminal of the main storage capacitor and a terminal of the main liquid crystal capacitor; the main storage capacitor has another terminal electrically connected to a common electrode on the array substrate side; the main liquid crystal capacitor has another terminal electrically connected to a common electrode on the CF substrate side;

the secondary region comprises a secondary TFT, a secondary storage capacitor, a secondary liquid crystal capacitor, and a divider capacitor series-connected to the secondary liquid crystal capacitor; the secondary TFT has its gate electrically connected to the scan line, its source electrically connected to the data line, and its drain electrically connected to a terminal of the secondary storage capacitor and a terminal of the divider capacitor; the secondary liquid crystal capacitor has another terminal electrically connected to the common electrode on the CF substrate side; the secondary storage capacitor has another terminal electrically connected to the common electrode on the array substrate side; and

the secondary liquid crystal capacitor has a voltage smaller than that of the main liquid crystal capacitor by the divider capacitor's voltage division.

Furthermore, a data signal on the data line charges the main region and the secondary region; and, after charge, a ratio between the voltage on the secondary liquid crystal capacitor and the voltage on the main liquid crystal capacitor is Cs/(Cs+Clc2), where

Cs and Clc2 are capacitances of the divider capacitor and secondary liquid crystal capacitor, respectively.

The secondary TFT has a ditch aspect ratio smaller than that of the main TFT so that the secondary TFT has a smaller charge rate than that of the main TFT.

Alternatively, the main region comprises a main TFT, a main storage capacitor, and a main liquid crystal capacitor; the main TFT has its gate electrically connected to the a scan line, its source electrically connected to a data line, and its drain electrically connected to a terminal of the main storage capacitor and a terminal of the main liquid crystal capacitor; the main storage capacitor has another terminal electrically connected to a common electrode on the array substrate side; the main liquid crystal capacitor has another terminal electrically connected to a common electrode on the CF substrate side;

the secondary region comprises a secondary TFT, a secondary storage capacitor, and a secondary liquid crystal capacitor; the secondary TFT has its gate electrically connected to the scan line, its source electrically connected to the data line, and its drain electrically connected to a terminal of the secondary storage capacitor and a terminal of the secondary liquid crystal capacitor; the secondary liquid crystal capacitor has another terminal electrically connected to a common electrode on the CF substrate side; the secondary storage capacitor has another terminal electrically connected to a common electrode on the array substrate side;

the secondary TFT has a ditch aspect ratio smaller than that of the main TFT so that the secondary TFT has a smaller charge rate than that of the main TFT, and so that the secondary liquid crystal capacitor has a voltage smaller than that of the main liquid crystal capacitor.

Preferably, the secondary TFT has a charge rate that is 70%˜80% to that of the main TFT.

The present invention also teaches a LCD panel, comprising a pixel driving circuit. The pixel driving circuit includes a main region and a secondary region. The main region comprises a main TFT, a main storage capacitor, and a main liquid crystal capacitor; the main TFT has its gate electrically connected to the a scan line, its source electrically connected to a data line, and its drain electrically connected to a terminal of the main storage capacitor and a terminal of the main liquid crystal capacitor; the main storage capacitor has another terminal electrically connected to a common electrode on the array substrate side; the main liquid crystal capacitor has another terminal electrically connected to a common electrode on the CF substrate side;

the secondary region comprises a secondary TFT, a secondary storage capacitor, a secondary liquid crystal capacitor, and a divider capacitor series-connected to the secondary liquid crystal capacitor; the secondary TFT has its gate electrically connected to the scan line, its source electrically connected to the data line, and its drain electrically connected to a terminal of the secondary storage capacitor and a terminal of the divider capacitor; the secondary liquid crystal capacitor has another terminal electrically connected to the common electrode on the CF substrate side; the secondary storage capacitor has another terminal electrically connected to the common electrode on the array substrate side; and

the secondary liquid crystal capacitor has a voltage smaller than that of the main liquid crystal capacitor by the divider capacitor's voltage division.

Furthermore, a data signal on the data line charges the main region and the secondary region; and, after charge, a ratio between the voltage on the secondary liquid crystal capacitor and the voltage on the main liquid crystal capacitor is Cs/(Cs+Clc2), where

Cs and Clc2 are capacitances of the divider capacitor and secondary liquid crystal capacitor, respectively.

The secondary TFT has a ditch aspect ratio smaller than that of the main TFT so that the secondary TFT has a smaller charge rate than that of the main TFT.

Alternatively, the main region comprises a main TFT, a main storage capacitor, and a main liquid crystal capacitor; the main TFT has its gate electrically connected to the a scan line, its source electrically connected to a data line, and its drain electrically connected to a terminal of the main storage capacitor and a terminal of the main liquid crystal capacitor; the main storage capacitor has another terminal electrically connected to a common electrode on the array substrate side; the main liquid crystal capacitor has another terminal electrically connected to a common electrode on the CF substrate side;

the secondary region comprises a secondary TFT, a secondary storage capacitor, and a secondary liquid crystal capacitor; the secondary TFT has its gate electrically connected to the scan line, its source electrically connected to the data line, and its drain electrically connected to a terminal of the secondary storage capacitor and a terminal of the secondary liquid crystal capacitor; the secondary liquid crystal capacitor has another terminal electrically connected to a common electrode on the CF substrate side; the secondary storage capacitor has another terminal electrically connected to a common electrode on the array substrate side;

the secondary TFT has a ditch aspect ratio smaller than that of the main TFT so that the secondary TFT has a smaller charge rate than that of the main TFT, and so that the secondary liquid crystal capacitor has a voltage smaller than that of the main liquid crystal capacitor.

Preferably, the secondary TFT has a charge rate that is 70%˜80% to that of the main TFT.

The advantages of the present invention are as follows. The pixel driving circuit of the present invention adopts a 2T structure to achieve color shift improvement by series-connecting a divider capacitor to the secondary liquid crystal capacitor, or by providing a secondary TFT with a ditch aspect ratio smaller than that of the main TFT. As such, the secondary liquid crystal capacitor has a voltage smaller than that of the main liquid crystal capacitor so that color shift is improved. Compared to the existing 3T-structure pixel driving circuit, the present invention omits the third TFT for discharging the secondary region and may remove the impact of the third TFT's discharge to the common electrode on the array substrate side, reduce lateral crosstalk, and further enhance pixel aperture ratio. The LCD panel of the present invention includes one of the above described pixel driving circuits and therefore has smaller color shift, less crosstalk, and better pixel aperture ratio.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a circuit diagram showing a conventional 3T-structure pixel driving circuit.

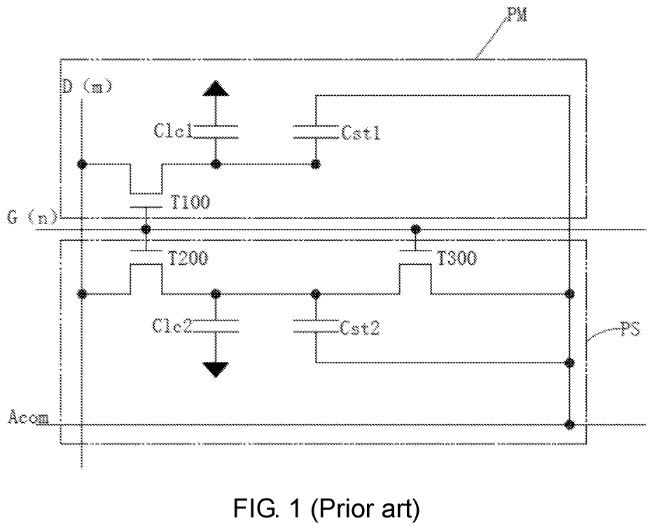

FIG. 2 is a circuit diagram showing a pixel driving circuit according to a first embodiment of the present invention.

FIG. 3 is a circuit diagram showing a pixel driving circuit according to a second embodiment of the present invention.

FIG. 4 is a circuit diagram showing a pixel driving circuit according to a third embodiment of the present invention.

### DETAILED DESCRIPTION OF PREFERRED EMBODIMENTS

The following descriptions for the respective embodiments are specific embodiments capable of being implemented for illustrations of the present invention with referring to appended figures.

The present invention teaches a pixel driving circuit.

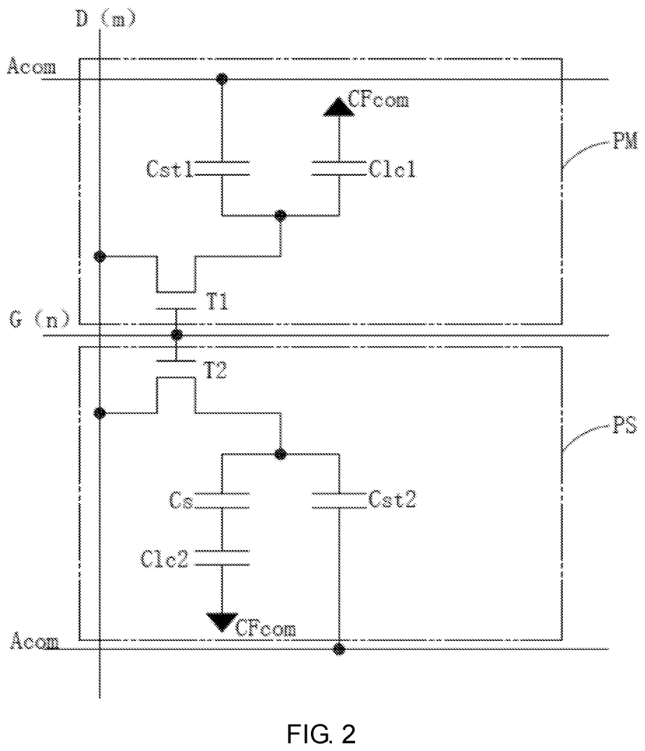

As shown in FIG. 2, a pixel driving circuit to a pixel according to a first embodiment of the present invention has a 2T structure involving two TFTs, and includes a main region PM and a secondary region PS.

A main TFT T1, a main storage capacitor Cst1, and a main liquid crystal capacitor Clc1 are provided in the main region PM. The main TFT T1 has its gate electrically connected to the a scan line G(n) where n is a positive integer indicating a row that the pixel is located, its source electrically connected to a data line D (m) where m a positive integer indicating a column that the pixel is located, and its drain electrically connected to a terminal of the main storage capacitor Cst1 and a terminal of the main liquid crystal capacitor Clc1 (i.e., the main region pixel electrode). The main storage capacitor Cst1 has another terminal electrically connected to a common electrode Acom on the array substrate side. The main liquid crystal capacitor Clc1 has another terminal electrically connected to a common electrode CFcom on the CF substrate side.

A secondary TFT T2, a secondary storage capacitor Cst2, a secondary liquid crystal capacitor Clc2, and a divider capacitor Cs series-connected to the secondary liquid crystal capacitor Clc2 are provided in the secondary region PS.

The secondary TFT T2 has its gate electrically connected to the scan line G(n), its source electrically connected to the data line D(m), and its drain electrically connected to a terminal of the divider capacitor Cs and a terminal of the secondary storage capacitor Cst2. The divider capacitor Cs has another terminal electrically connected to a terminal of the secondary liquid crystal capacitor Clc2 (i.e., secondary region pixel electrode). The secondary liquid crystal capacitor Clc2 has another terminal electrically connected to the common electrode CFcom on the CF substrate side. The secondary storage capacitor Cst2 has another terminal electrically connected to the common electrode Acom on the array substrate side.

Compared to the existing 3T-structure pixel driving circuit, the present embodiment omits the third TFT for discharging the secondary region. Instead, a divider capacitor Cs is provided to achieve voltage division with the secondary liquid crystal capacitor Clc2. When a scan signal on the scan line G(n) functions, the main TFT T1 in the main region PM is turned on, a data signal on the data line D(m) charges the main storage capacitor Cst1, the main liquid crystal capacitor Clc1. In the meantime, the secondary TFT T2 in the secondary region PS is turned on, the data signal on the data line D(m) charges the secondary storage capacitor Cst2, the divider capacitor Cs, and the secondary liquid crystal capacitor Clc2. Assuming that the common electrode CFcom on the CF substrate side has a voltage V_{data}, the main liquid crystal capacitor Clc1 would have a voltage V_{Clc1} equal to V_{data} after the scan signal on the scan line G(n) stops and the main liquid crystal capacitor Clc1 is charged. That is,

V_{Clc1}=V_{data} (1)

After the secondary liquid crystal capacitor Clc2 and the divider capacitor Cs are charged, the sum of the secondary liquid crystal capacitor Clc2's voltage V_{Clc2} and the divider capacitor Cs' voltage V_{Cs} is equal to V_{data}. That is,

V_{Clc2}+V_{Cs}=V_{data}

According to voltage division principle, the voltage V_{Clc2} on the secondary liquid crystal capacitor Clc2 is as follows:

V_{Clc2}=V_{data}×Cs/(Cs+Clc2) (2)

Dividing Eq.(1) by Eq.(2), the ratio between the voltages on the secondary liquid crystal capacitor Clc2 and the main liquid crystal capacitor Clc1 is as follows:

V_{Clc2}/V_{Clc1}=V_{data}×Cs/(Cs+Clc2)/V_{data}=Cs/(Cs+Clc2) (3)

As such, by providing the divider capacitor Cs, its voltage division effect causes that the secondary liquid crystal capacitor Clc2 has a voltage smaller than that of the main liquid crystal capacitor Clc1, thereby improving color shift.

Compared to the existing 3T-structure pixel driving circuit, the present embodiment omits the third TFT for discharging the secondary region and may remove the impact of the third TFT's discharge to the common electrode Acom on the array substrate side, reduce lateral crosstalk, and further enhance pixel aperture ratio.

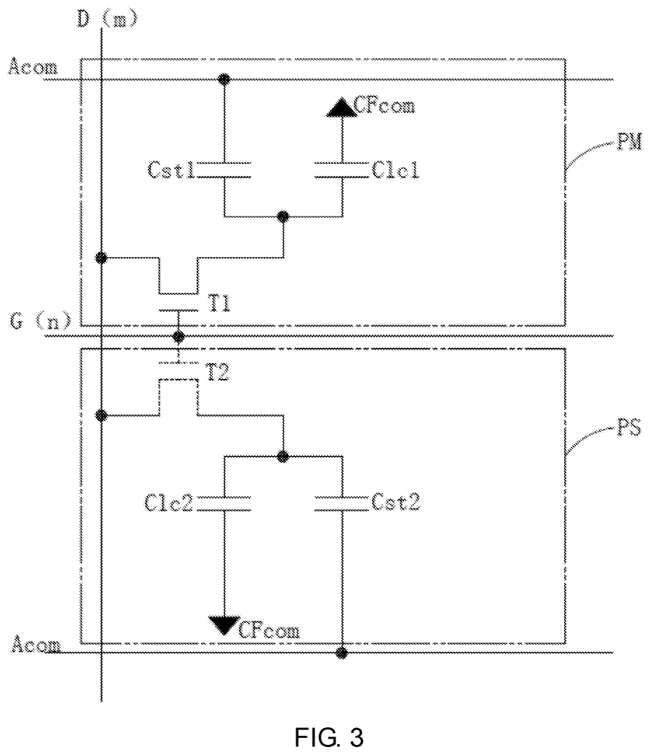

As shown in FIG. 3, a pixel driving circuit to a pixel according to a second embodiment of the present invention has a 2T structure, and includes a main region PM and a secondary region PS.

A main TFT T1, a main storage capacitor Cst1, and a main liquid crystal capacitor Clc1 are provided in the main region PM. The main TFT T1 has its gate electrically connected to a scan line G(n), its source electrically connected to a data line D (m), and its drain electrically connected to a terminal of the main storage capacitor Cst1 and a terminal of the main liquid crystal capacitor Clc1 (i.e., the main region pixel electrode). The main storage capacitor Cst1 has another terminal electrically connected to a common electrode Acom on the array substrate side. The main liquid crystal capacitor Clc1 has another terminal electrically connected to a common electrode CFcom on the CF substrate side.

A secondary TFT T2, a secondary storage capacitor Cst2, a secondary liquid crystal capacitor Clc2 are provided in the secondary region PS. The secondary TFT T2 has its gate electrically connected to the scan line G(n), its source electrically connected to the data line D(m), and its drain electrically connected to a terminal of the secondary storage capacitor Cst2 and a terminal of the secondary liquid crystal capacitor Clc2 (i.e., secondary region pixel electrode). The secondary liquid crystal capacitor Clc2 has another terminal electrically connected to the common electrode CFcom on the CF substrate side. The secondary storage capacitor Cst2 has another terminal electrically connected to the common electrode Acom on the array substrate side.

It should be noted that TFT's ditch aspect ratio is an important factor in determining the TFT's charge rate. A greater ditch aspect ratio would lead to higher TFT charge rate. In the present embodiment, the secondary TFT T2 has a ditch aspect ratio smaller than that of the main TFT T1 by, during the manufacturing process, increasing the secondary TFT T2's ditch length while keeping the ditch width unchanged, or keeping the secondary TFT T2's ditch length unchanged but reducing the ditch width. When a scan signal on the scan line G(n) functions, the main TFT T1 in the main region PM is turned on, a data signal on the data line D(m) charges the main storage capacitor Cst1, the main liquid crystal capacitor Clc1 through the main TFT T1. In the meantime, the secondary TFT T2 in the secondary region PS is turned on, the data signal on the data line D(m) charges the secondary storage capacitor Cst2 and the secondary liquid crystal capacitor Clc2 through the secondary TFT T2. As the secondary TFT T2 has a ditch aspect ratio smaller than that of the main TFT T1, the secondary TFT T2 has a smaller charge rate than that of the main TFT T1. Preferably, the secondary TFT T2 has a charge rate that is 70%˜80% to that of the main TFT T1. As such, the secondary liquid crystal capacitor Clc2 has a voltage after charge smaller than that of the main liquid crystal capacitor Clc1, thereby improving color shift.

The present embodiment reduces the ditch aspect ratio of the secondary TFT T2 so that the secondary liquid crystal capacitor Clc2 has a voltage smaller than that of main liquid crystal capacitor Clc1 and so that color shift is improved. Compared to the existing 3T-structure pixel driving circuit, the present embodiment omits the third TFT for discharging the secondary region and may remove the impact of the third TFT's discharge to the common electrode Acom on the array substrate side, reduce lateral crosstalk, and further enhance pixel aperture ratio.

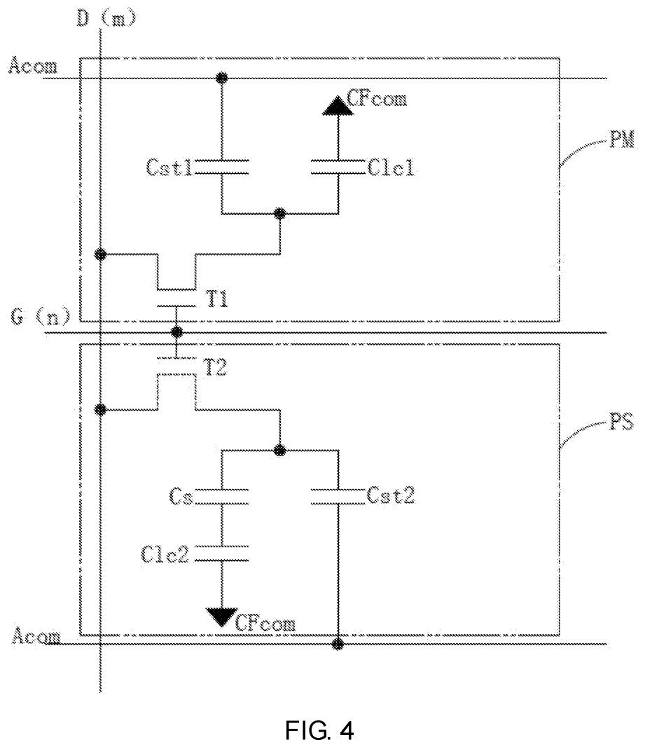

As shown in FIG. 4, a pixel driving circuit according to a third embodiment of the present invention is a combination of the previous first and second embodiments. That is, while providing a divider capacitor Cs series-connected to the secondary liquid crystal capacitor Clc2, the present embodiment also reduces the ditch aspect ratio of the secondary TFT T2 so that the secondary TFT T2 has a smaller ditch aspect ratio than that of the main TFT T1. The present embodiment as such may, to a greater degree, cause the voltage on the secondary liquid crystal capacitor Clc2 to be smaller than the voltage on the main liquid crystal capacitor Clc1, thereby improving color shift. Compared to the existing 3T-structure pixel driving circuit, the present embodiment omits the third TFT for discharging the secondary region and may remove the impact of the third TFT's discharge to the common electrode Acom on the array substrate side, reduce lateral crosstalk, and further enhance pixel aperture ratio.

The present invention also teaches a LCD panel including one of the above described pixel driving circuits and therefore having smaller color shift, less crosstalk, and better pixel aperture ratio.

As described above, the pixel driving circuit of the present invention adopts a 2T structure to achieve color shift improvement by series-connecting a divider capacitor to the secondary liquid crystal capacitor, or by providing a secondary TFT with a ditch aspect ratio smaller than that of the main TFT. As such, the secondary liquid crystal capacitor has a voltage smaller than that of the main liquid crystal capacitor so that color shift is improved. Compared to the existing 3T-structure pixel driving circuit, the present invention omits the third TFT for discharging the secondary region and may remove the impact of the third TFT's discharge to the common electrode Acom on the array substrate side, reduce lateral crosstalk, and further enhance pixel aperture ratio. The LCD panel of the present invention includes one of the above described pixel driving circuits and therefore has smaller color shift, less crosstalk, and better pixel aperture ratio.

Above are embodiments of the present invention, which does not limit the scope of the present invention. Any equivalent amendments within the spirit and principles of the embodiment described above should be covered by the protected scope of the invention.

What is claimed is:

1. A pixel driving circuit, comprising a main region and a secondary region, wherein
the main region comprises a main thin film transistor (TFT), a main storage capacitor, and a main liquid crystal capacitor; the main TFT has its gate electrically connected to the a scan line, its source electrically connected to a data line, and its drain electrically connected to a terminal of the main storage capacitor and a terminal of the main liquid crystal capacitor; the main storage capacitor has another terminal electrically connected to a common electrode on the array substrate side; the main liquid crystal capacitor has another terminal electrically connected to a common electrode on the color filter (CF) substrate side;
the secondary region comprises a secondary TFT, a secondary storage capacitor, a secondary liquid crystal capacitor, and a divider capacitor series-connected to the secondary liquid crystal capacitor; the secondary TFT has its gate electrically connected to the scan line, its source electrically connected to the data line, and its drain electrically connected to a terminal of the secondary storage capacitor and a terminal of the divider capacitor; the secondary liquid crystal capacitor has another terminal electrically connected to the common electrode on the CF substrate side; the secondary storage capacitor has another terminal electrically connected to the common electrode on the array substrate side; and the secondary liquid crystal capacitor has a voltage smaller than that of the main liquid crystal capacitor by the divider capacitor's voltage division.

2. The pixel driving circuit according to claim 1, wherein a data signal on the data line charges the main region and the secondary region; and, after charge, a ratio between the voltage on the secondary liquid crystal capacitor and the voltage on the main liquid crystal capacitor is Cs/(Cs+Clc2), where
Cs and Clc2 are capacitances of the divider capacitor and secondary liquid crystal capacitor, respectively.

3. The pixel driving circuit according to claim 1, wherein the secondary TFT has a ditch aspect ratio smaller than that of the main TFT so that the secondary TFT has a smaller charge rate than that of the main TFT.

4. A liquid crystal display (LCD) panel, comprising a pixel driving circuit, wherein the pixel driving circuit comprises a main region and a secondary region;
the main region comprises a main thin film transistor (TFT), a main storage capacitor, and a main liquid crystal capacitor; the main TFT has its gate electrically connected to the a scan line, its source electrically connected to a data line, and its drain electrically connected to a terminal of the main storage capacitor and a terminal of the main liquid crystal capacitor; the main storage capacitor has another terminal electrically connected to a common electrode on the array substrate side; the main liquid crystal capacitor has another terminal electrically connected to a common electrode on the color filter (CF) substrate side;
the secondary region comprises a secondary TFT, a secondary storage capacitor, a secondary liquid crystal capacitor, and a divider capacitor series-connected to the secondary liquid crystal capacitor; the secondary TFT has its gate electrically connected to the scan line, its source electrically connected to the data line, and its drain electrically connected to a terminal of the secondary storage capacitor and a terminal of the divider capacitor; the secondary liquid crystal capacitor has another terminal electrically connected to the common electrode on the CF substrate side; the secondary storage capacitor has another terminal electrically connected to the common electrode on the array substrate side; and
the secondary liquid crystal capacitor has a voltage smaller than that of the main liquid crystal capacitor by the divider capacitor's voltage division.

5. The LCD panel according to claim 4, wherein a data signal on the data line charges the main region and the secondary region; and, after charge, a ratio between the voltage on the secondary liquid crystal capacitor and the voltage on the main liquid crystal capacitor is Cs/(Cs+Clc2), where
Cs and Clc2 are capacitances of the divider capacitor and secondary liquid crystal capacitor, respectively.

6. The LCD panel according to claim 4, wherein the secondary TFT has a ditch aspect ratio smaller than that of the main TFT so that the secondary TFT has a smaller charge rate than that of the main TFT.

7. A LCD panel, comprising a pixel driving circuit, wherein the pixel driving circuit comprises a main region and a secondary region;
the main region comprises a main thin film transistor (TFT), a main storage capacitor, and a main liquid crystal capacitor; the main TFT has its gate electrically connected to the a scan line, its source electrically connected to a data line, and its drain electrically connected to a terminal of the main storage capacitor and a terminal of the main liquid crystal capacitor; the main storage capacitor has another terminal electrically connected to a common electrode on the array substrate side; the main liquid crystal capacitor has another terminal electrically connected to a common electrode on the color filter (CF) substrate side;
the secondary region comprises a secondary TFT, a secondary storage capacitor, and a secondary liquid crystal capacitor; the secondary TFT has its gate electrically connected to the scan line, its source electrically connected to the data line, and its drain electrically connected to a terminal of the secondary storage capacitor and a terminal of the secondary liquid crystal capacitor; the secondary liquid crystal capacitor has another terminal electrically connected to a common electrode on the CF substrate side; the secondary storage capacitor has another terminal electrically connected to a common electrode on the array substrate side;
the secondary TFT has a ditch aspect ratio smaller than that of the main TFT so that the secondary TFT has a smaller charge rate than that of the main TFT, and so that the secondary liquid crystal capacitor has a voltage smaller than that of the main liquid crystal capacitor.

8. The LCD panel according to claim 7, wherein the secondary TFT has a charge rate that is 70%˜80% to that of the main TFT.
